(19) United States
(12) Patent Application Publication
(10) Pub. No.: US 2026/0220081 A1
(43) Pub. Date: Jul. 30, 2026

(54) COMPONENT INITIALIZATION IN A RECONFIGURABLE DATAFLOW ARCHITECTURE

(71) Applicant: SambaNova Systems, Inc., Palo Alto, CA (US)

(72) Inventors: Arjun SABNIS, San Francisco, CA (US); Pushkar Shridhar NANDKAR, Hayward, CA (US); Juan DOMINGUEZ, Palo Alto, CA (US); Benjamin GLICK, Palo Alto, CA (US); Conrad Alexander TURLIK, Menlo Park, CA (US); Rui YUAN, San Ramon, CA (US); Chih-Hao WANG, Santa Clara, CA (US)

(73) Assignee: SambaNova Systems, Inc., Palo Alto, CA (US)

(21) Appl. No.: 19/037,819

(22) Filed: Jan. 27, 2025

(51) Int. Cl. G06F 15/78; G06F 13/16

(52) U.S. Cl. CPC G06F 15/7892; G06F 13/16

(57) ABSTRACT

A system includes a plurality of reconfigurable dataflow units (RDUs) including a first RDU coupled together using a local interconnect. The first RDU includes a first interface to a PCU and a PMU accessible to and integrated with the PCU. The first RDUs is configured to receive configuration information via the local interconnect, while the configuration information indicates first initialization information usable to initialize the PCU via the first interface and second initialization information usable to initialize the PMU via the first interface.

### BACKGROUND

### Field of the Disclosure

The present disclosure relates generally to a reconfigurable dataflow architecture and, more particularly, to methods and systems for component initialization in a reconfigurable dataflow architecture.

### Description of the Related Art

Data processing and computer science have seen a revolution in learning capability and performance with the advent of artificial intelligence (AI) and machine learning (ML) based on neural networks (NN) as a core topology using parallel processing algorithms. Many AI/ML applications have been performed by conventional computer architectures based on sequential control flow, in which an instruction set is sequentially executed by a central processing unit (CPU). However, very large AI/ML workloads, such as involved with large language models (LLMs), may not be particularly well matched with the capabilities of CPU based computer system.

Therefore, in addition to the CPU, computer systems including a graphics processing unit (GPU) have been used to accelerate the parallel processing involved with AI/ML workloads. GPUs that were designed to accelerate graphics output to a display were found to also accelerate the AI/ML workloads in a similar manner. The use of CPU/GPU computer systems may provide a limited potential for acceleration of AI/ML workloads, and in particular very large AI/ML workloads, due to constraints with memory access as well as due to overall power consumption, which can be undesirable.

### SUMMARY

In one aspect, a system for component initialization in a reconfigurable dataflow architecture is disclosed. The system may include a plurality of reconfigurable dataflow units (RDUs) including a first RDU coupled together using a local interconnect. In the system, the first RDU may further include a first interface to a pattern compute unit (PCU) and to a pattern memory unit (PMU) accessible to and integrated with the PCU. In the system, the first RDU may be configured to receive configuration information via the local interconnect. In the system, the configuration information may indicate first initialization information usable to initialize the PCU via the first interface, and second initialization information usable to initialize the PMU via the first interface.

In any of the disclosed embodiments of the system, the first RDU may further include a second interface to the local interconnect, a third interface to a high-bandwidth memory (HBM) accessible to the PCU, and a fourth interface to a dual data rate (DDR) memory accessible to the PCU. In the system, the configuration information may further indicate third initialization information usable to initialize the local interconnect via the second interface, fourth initialization information usable to initialize HBM via the third interface, and fifth initialization information usable to initialize the DDR memory via the fourth interface.

In any of the disclosed embodiments of the system, the first RDU may further include a first die and a second die communicatively coupled using a die-to-die (D2D) interface, and a fifth interface to the D2D interface. In the system, the configuration information may further indicate sixth initialization information to initialize the D2D interface via the fifth interface.

In any of the disclosed embodiments of the system, the local interconnect may include or may be coupled to a system interconnect accessible to a host in communication with the system.

In any of the disclosed embodiments of the system, the system interconnect may include or may be coupled to to at least one of a peripheral component interconnect (PCI) bus, an optical interconnect, or an Ethernet network.

In any of the disclosed embodiments of the system, the configuration information may be sent by the host from a user space process using the system interconnect.

In any of the disclosed embodiments of the system, the user space process may be configured to access control and status registers (CSRs) in the first RDU.

In any of the disclosed embodiments of the system, the first die may further include a sixth interface to a reconfigurable dataflow network (RDN) in communication with the PCU and the PMU, and a seventh interface to a top-level network (TLN) in communication with the RDN, and wherein the configuration information may further indicate seventh initialization information to initialize the RDN via the sixth interface, and eighth initialization information usable to initialize the TLN via the seventh interface.

In any of the disclosed embodiments of the system, the first die may further include an eighth interface to an address generation and coalescing unit (AGCU), while the configuration information may further indicate ninth initialization information to initialize the AGCU via the eighth interface.

In another aspect, a method for component initialization in a reconfigurable dataflow architecture is disclosed. The method may include accessing, at a host, configuration information indicating initialization information for a system comprising a plurality of reconfigurable dataflow units (RDUs), including a first RDU, coupled together using a local interconnect. The method may further include sending the configuration information to the system using a system interconnect included with or coupled to the local interconnect, including sending at least some of the configuration information to the first RDU. The method may further include sending, to a first interface at the first RDU, first initialization information indicated in the configuration information, the first initialization information usable to initialize a pattern compute unit (PCU) included in the first RDU. sending, to the first interface, second initialization information indicated in the configuration information, the second initialization information usable to initialize a pattern memory unit (PMU) accessible to and integrated with the PCU. The method may also include sending, to a second interface at the first RDU, third initialization information indicated in the configuration information, the third initialization information usable to initialize the local interconnect, sending, to a third interface at the first RDU, fourth initialization information indicated in the configuration information, the fourth initialization information usable to initialize a high-bandwidth memory (HBM) accessible to the PCU, and sending, to a fourth interface at the first RDU, fifth initialization information indicated in the configuration information, the fifth initialization information usable to initialize a dual data rate (DDR) memory accessible to the PCU.

In any of the disclosed embodiments of the method, the system interconnect may include or may be coupled to at least one of a peripheral component interconnect (PCI) bus, an optical interconnect, or an Ethernet network.

In any of the disclosed embodiments, the method may further include, initializing the PCU using the first initialization information, initializing the PMU using the second initialization information, initializing the local interconnect using the third initialization information, initializing the HBM using the fourth initialization information, and initializing the DDR memory using the fifth initialization information.

In any of the disclosed embodiments, the method may further include sending, to a fifth interface at the first RDU, sixth initialization information indicated in the configuration information and usable to initialize a die-to-die (D2D) interface that communicatively couples a first die and a second die included in the first RDU, and sending, to a sixth interface at the first RDU, seventh initialization information indicated in the configuration information and usable to initialize an address generation and coalescing unit (AGCU) included in the first RDU. The method may further include initializing the D2D interface using the sixth initialization information, and initializing the AGCU using the seventh initialization information.

In any of the disclosed embodiments, the method may further include sending, to a seventh interface at the first RDU, eighth initialization information indicated in the configuration information and usable to initialize a reconfigurable dataflow network (RDN) included in the first RDU and sending, to a eighth interface at the first RDU, ninth initialization information indicated in the configuration information and usable to initialize a top-level network (TLN) included in the first RDU. The method may further include initializing the RDN using the eighth initialization information, and initializing the TLN using the ninth initialization information.

In yet another aspect, tangible computer-readable media comprising instructions executable by a computer system for component initialization in a reconfigurable dataflow architecture are disclosed. The computer-readable media may include instructions to access, at a host, configuration information indicating initialization information for a system comprising a plurality of reconfigurable dataflow units (RDUs), including a first RDU, coupled together using a local interconnect. The computer-readable media may also include instructions to send the configuration information to the system using a system interconnect included with or coupled to the local interconnect, including sending at least some of the configuration information to the first RDU. The computer-readable media may include instructions to send, to a first interface at the first RDU, first initialization information indicated in the configuration information, the first initialization information usable to initialize a pattern compute unit (PCU) included in the first RDU. The computer-readable media may include instructions to send, to the first interface, second initialization information indicated in the configuration information, the second initialization information usable to initialize a pattern memory unit (PCU) accessible to and integrated with the PCU. The computer-readable media may further include instructions to send, to a second interface at the first RDU, third initialization information indicated in the configuration information, the third initialization information usable to initialize the local interconnect. The computer-readable media may include instructions to send, to a third interface at the first RDU, fourth initialization information indicated in the configuration information, the fourth initialization information usable to initialize a high-bandwidth memory (HBM) accessible to the PCU. The computer-readable media may also include instructions to send, to a fourth interface at the first RDU, fifth initialization information indicated in the configuration information, the fifth initialization information usable to initialize a dual data rate (DDR) memory accessible to the PCU.

In any of the disclosed embodiments of the computer-readable media, the system interconnect may include or may be coupled to at least one of a peripheral component interconnect (PCI) bus, an optical interconnect, or an Ethernet network.

In any of the disclosed embodiments, the computer-readable media may include instructions executable by the computer system to initialize the PCU using the first initialization information, initialize the PMU using the second initialization information, initialize the local interconnect using the third initialization information, initialize the HBM using the fourth initialization information, and initialize the DDR memory using the fifth initialization information.

In any of the disclosed embodiments, the computer-readable media may include instructions executable by the computer system to send, to a fifth interface at the first RDU, sixth initialization information indicated in the configuration information and usable to initialize a die-to-die (D2D) interface that communicatively couples a first die and a second die included in the first RDU. The computer-readable media may further include instructions to send, to a sixth interface at the first RDU, seventh initialization information indicated in the configuration information and usable to initialize an address generation and coalescing unit included in the first RDU. The computer-readable media may also include instructions to initialize the D2D interface using the sixth initialization information, and initialize the address generation and coalescing unit using the seventh initialization information.

In any of the disclosed embodiments, the computer-readable media may include instructions executable by the computer system to send, to a seventh interface at the first RDU, eighth initialization information indicated in the configuration information and usable to initialize a reconfigurable dataflow network (RDN) included in the first RDU. The computer-readable media may include instructions to send, to a eighth interface at the first RDU, ninth initialization information indicated in the configuration information and usable to initialize a top-level network (TLN) included in the first RDU. The computer-readable media may include instructions to initialize the RDN using the eighth initialization information, and to initialize the TLN using the ninth initialization information.

In any of the disclosed embodiments of the computer-readable media, the computer system may be the host.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of a reconfigurable dataflow architecture, in one embodiment;

FIG. 2 is a block diagram of a high-performance computer (HPC) host, in one embodiment;

FIG. 3 is a block diagram of a computer system host, in one embodiment;

FIG. 4 is a depiction of a neural network model, in one embodiment;

FIG. 5 is a block diagram of a reconfigurable dataflow unit (RDU) system compilation, in one embodiment;

FIG. 6 is a block diagram of a reconfigurable dataflow runtime (RDRT) architecture, in one embodiment;

FIG. 7 is a block diagram of an RDU, in one embodiment;

FIG. 8 is a block diagram of an RDU die, in one embodiment;

FIG. 9 is a block diagram of an RDU tile, in one embodiment;

FIG. 10 is a block diagram of a system interconnect memory mapping, in one embodiment;

FIG. 11 is a block diagram of a management and control bus (MCB) 1100, in one embodiment; and

FIG. 12 is a flow chart of a method for component initialization, in one embodiment.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

As noted previously, typical CPU/GPU computer architectures may be constrained in performance and power consumption, especially for processing very large AI/ML workloads. To overcome certain limitations of typical CPU/GPU computer architectures, a reconfigurable dataflow architecture, as further described in detail herein, has been developed. In particular, the reconfigurable dataflow architecture can provide parallel processing using multiple compute units that are simpler than typical CPUs, and therefore, can operate faster and consume less power for comparable workloads. The reconfigurable dataflow architecture may be particularly suited for AI/ML workloads associated with respective layers or stages in a NN defining a computational model for execution, and may be dimensioned or scaled for very large AI/ML workloads corresponding to very large NNs.

The AI/ML workload executed by the reconfigurable dataflow architecture may include training procedures for developing and tuning a particular model, such as an LLM. The AI/ML workload executed by the reconfigurable dataflow architecture may also include usage of a trained model to generate desired output from input, also referred to as ‘inference’ using the trained model.

The reconfigurable dataflow architecture may accordingly include various embedded hardware components that are organized in a hierarchical structure. As will be described in further detail herein, because the reconfigurable dataflow architecture is comprised of modular components that are designed for scalable expansion, a large number of instances of the embedded hardware components may be used. Therefore, even when a total number of different types of embedded hardware components in the reconfigurable dataflow architecture may be relatively small, an overall large number of individual instances of the embedded hardware components can be used and operated.

The usage and operation of the embedded hardware components in the reconfigurable dataflow architecture involves management and control of each individual instance of the components used. For example, certain embedded hardware components can themselves respectively include a local controller that can execute instructions, such as instructions or code in firmware that is executable by the local controller to configure and operate a respective component. In particular, the instructions or code in firmware can include initialization information usable to initialize the respective component into a desired state, such as upon startup. Thus, the large number of individual instances of embedded hardware components used in the reconfigurable dataflow architecture can correspond to a large number of respective controllers, each having respective firmware.

As noted, the reconfigurable dataflow architecture includes relatively simple modular components that are designed for parallelized workloads, such as AI/ML workloads. In the reconfigurable dataflow architecture, the coordination and control of workload processing is performed by a ‘host’ that is an external computer system that may operate using a conventional CPU and a corresponding operating system that supports sequential processing of instructions fed to the CPU, among other data processing capabilities. Accordingly, various management and configuration tasks for the reconfigurable dataflow architecture may be performed within the operating system executing at the host.

One management and configuration task typically performed using conventional computer systems is initialization of embedded components, or sub-components, such as for use with the operating system. In such conventional computer systems, a separate basic input/output system (BIOS) is typically used as a central controller with central firmware for managing and configuring the various other embedded components, such as memory, storage adapters, network adapters, peripheral buses, among others, which are often collectively referred to as ‘peripheral’ components to the CPU. Additionally, device drivers that support access from within the operating system to hardware interfaces can be installed and used to support various peripheral components.

As a result, the conventional computer system can have a centralized management and configuration that is included within the operating system, while the number of instances of individual embedded hardware components can be very small and is often one (1).

As will be described in further detail, due to the different design and operation of the reconfigurable dataflow architecture, as compared with a conventional computer system, a component commensurate to the BIOS is not generally used. Furthermore, execution of workload threads on the hardware of the reconfigurable dataflow architecture can be performed without direct involvement of the operating system on the host.

As disclosed herein, a reconfigurable dataflow architecture may include a plurality of RDUs that are coupled together using a local interconnect. Each of the RDUs may, in turn, include different interfaces, such as in a management and control bus, that respectively support different hardware components and that can access the local interconnect. The different interfaces may include respective controllers that can execute respective firmware to configure and operate the respective hardware component, as well as to update the respective firmware itself by replacing existing firmware with a new version of the firmware.

The reconfigurable dataflow architecture disclosed herein may also include a host that communicates with the RDUs using the local interconnect. In this manner, the host can collectively manage configuration information for the plurality of RDUs that form the RDU system. The configuration information can further include respective initialization information for respective hardware components within each RDU in the RDU system, for example, such as initialization information in the form of firmware executable by the respective interface for the hardware component. Accordingly, the initialization information can define a desired startup state or operating mode for the respective hardware component in the RDU system.

In the reconfigurable dataflow architecture disclosed herein, the configuration information may be collected, curated, and stored at the host for the RDU system, including the initialization information for the hardware components and respective interfaces within each RDU. For example, certain hardware components may be defined by intellectual property (IP) of a vendor of the hardware component, such as a proprietary circuit design that was obtained from the vendor for use in the RDU. The vendor may also supply the initialization information, such as firmware, for the vendor's hardware component that is then collected at the host. For example, the vendor may release updated versions of the initialization information at regular or irregular intervals to the vendor's customers.

In the reconfigurable dataflow architecture disclosed herein, a reconfigurable dataflow runtime (RDRT) supervisor is disclosed as a software application running on the host that performs various management tasks on the RDU system. The management tasks performed by the RDRT supervisor can include initialization of the hardware components in the RDU system. Accordingly, the RDRT supervisor can be enabled to access the configuration information and to communicate with the RDU system to send respective initialization information to respective hardware components in the RDU system, as well as causing the respective interfaces for each hardware component to be updated with the initialization information.

Because the configuration information may be maintained separate from the source code of the RDRT supervisor itself, the complexity and version management of the RDRT supervisor can be reduced over a service lifetime. Because the initialization information for each embedded hardware component in the RDU system may be individually maintained at the host, a change in the initialization for one hardware component can be made without affecting any other hardware component, which is desirable. Furthermore, the scalability of the RDRT supervisor to support large numbers of different types of hardware components can be improved, such as by curating different versions or generations of the initialization information in the configuration information, without necessarily changing the scope or complexity of the RDRT supervisor itself.

In the reconfigurable dataflow architecture disclosed herein, different use cases for curating the configuration information at the host may apply. In in one use case, customized versions of the initialization information may be developed independently of the vendor. The effort to develop customized versions of the initialization information may include testing and evaluation related to performance of the initialization information on the RDU system in operation. In another use case, different implementations of the RDU may be developed with different types or numbers of hardware components. Thus, the configuration information may be curated for different RDU types that are developed and released over the product lifetime.

While the prior discussion of configuration information was described with respect to embedded hardware components in the RDU, as will be described in further detail, yet another use case for curating the configuration information at the host can include the ability to scale the RDU system itself with different numbers of processing elements, such as RDUs, GPUs, or CPUs, for example, for particular workloads or tasks. In this case, the configuration information can include initialization information for various types and numbers of the processing elements, while maintaining an identical or similar version of the RDRT supervisor for execution at the host for different use cases.

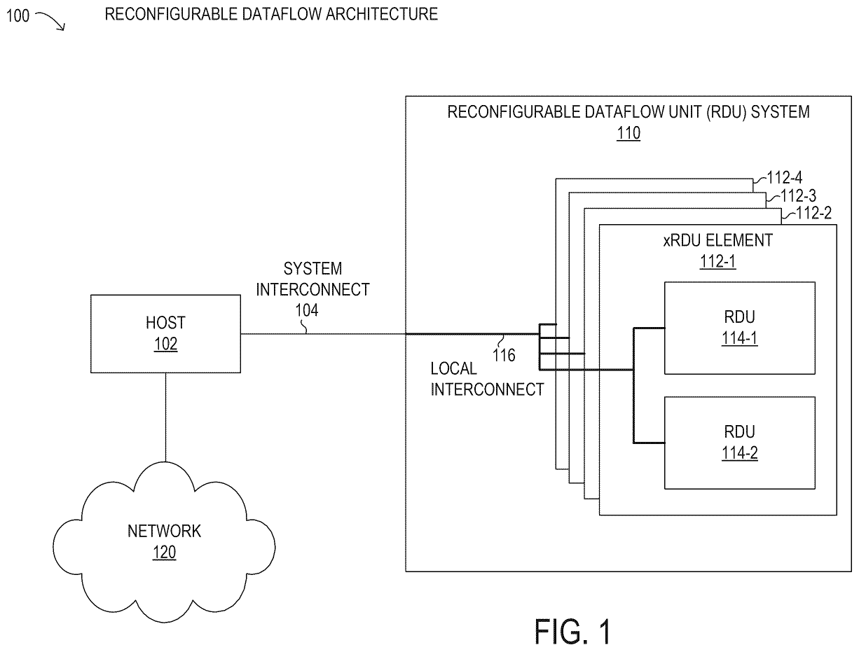

Referring now to the drawings, FIG. 1 depicts a block diagram of a reconfigurable dataflow architecture 100, or simply referred to as architecture 100, in one embodiment. FIG. 1 is a schematic illustration and is not necessarily drawn to scale or perspective. FIG. 1 is an exemplary implementation of reconfigurable dataflow architecture 100 for descriptive purposes. In some embodiments, reconfigurable dataflow architecture 100 may include or represent various different components and interconnections. As shown in FIG. 1, reconfigurable dataflow architecture 100 includes a host 102 coupled to an RDU system 110 by a system interconnect 104, while host 102 is also coupled to a network 120.

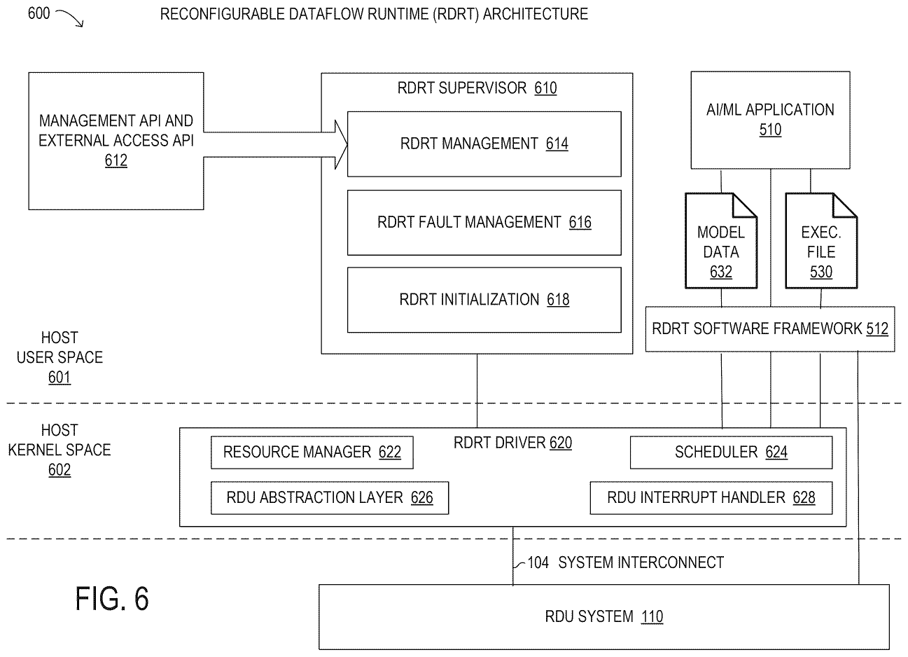

In general terms, reconfigurable dataflow architecture 100, which includes RDRT architecture 600 (see FIG. 6) is capable of managing graph execution and hardware resources of RDU system 110. In particular, reconfigurable dataflow architecture 100 can support data-flow AI/ML applications, such as ML training, low-latency inference, and extract-transform-load (ETL) enterprise processes. As will be described in further detail, reconfigurable dataflow architecture 100 is a modular architecture that is scalable for different types and sizes of workloads. For example, RDU system 110 can be scaled to use any number of RDUs 114, such as from 1 to 1024 or more in various embodiments. Various features and capabilities of reconfigurable dataflow architecture 100, whether in hardware or in software, have been designed and optimized for maximum or optimal compute performance and device memory utilization. In particular, reconfigurable dataflow architecture 100 can provide for efficient data exchange between host 102 and device memory included in RDU system 110, for example, by consuming low overhead of an operating system executing on host 102 during data exchange over system interconnect 104. Additionally, reconfigurable dataflow architecture 100 provides various tools and utilities for orchestration of model execution, including for execution management, debugging, and profiling, among others.

As shown in FIG. 1, network 120 can represent any of a variety of network systems, such a local area network (LAN), a wide area network (WAN) or combinations thereof. Network 120 can include or support wired and wireless network connections. In some embodiments, network 120 can include private network domains or public network domains, such as the Internet, or both public and private network domains. In particular embodiments, network 120 can be optional such that network 120 is not used, or access to network 120 by host 102 is blocked or prevented, in which case host 102 and RDU system 110 can operate privately without network access.

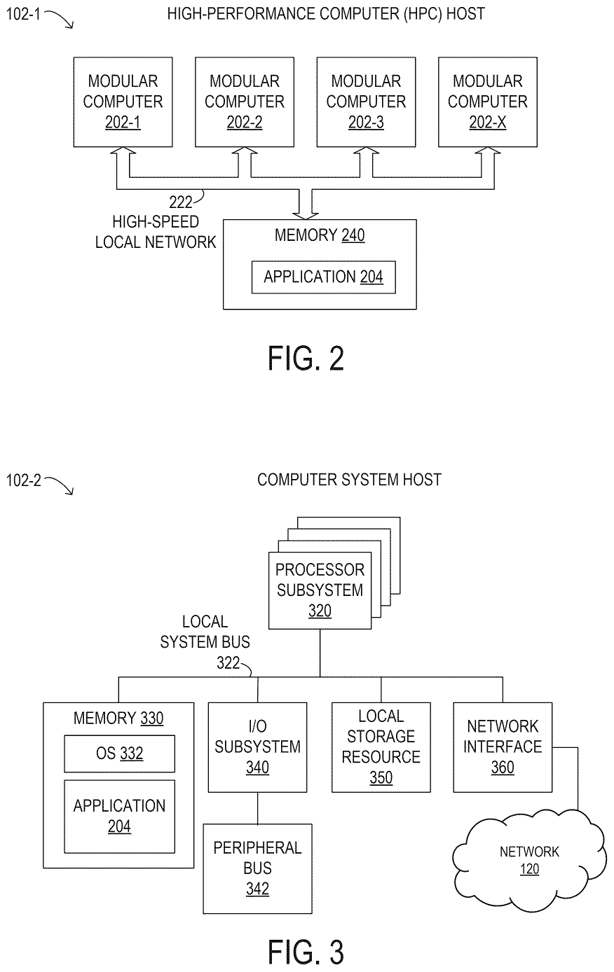

As shown in FIG. 1, host 102 can represent any of a variety of computer systems that can operate using a CPU and a corresponding operating system to enable the execution of software on host 102 using the CPU. In particular embodiments, host 102 can represent at least certain portions of a computer system host 102-2 (see FIG. 3) or a high-performance computer (HPC) host 102-1 (see FIG. 2), as will be discussed in further detail below. The operating system executing on host 102 may enable the execution of software to control RDU system 110, such as by providing a user space for general processing task execution and a kernel space for hardware input/output (I/O) driver execution (see also FIG. 3), among other tasks or processes. In this manner, RDU system 110 can be exclusively controlled and operated by host 102, as will be described in further detail. Specifically, host 102 can be loaded with various software components and tools to enable development and execution of an application that can be executed using RDU system 110 for accelerated execution. The various software components and tools executing on host 102 can be developed for and integrated with RDU system 110. For example, the various software components and tools used at host 102 to control RDU system 110 can be developed and supplied by a manufacturer of RDU system 110 for the specific purpose of operating RDU system 110.

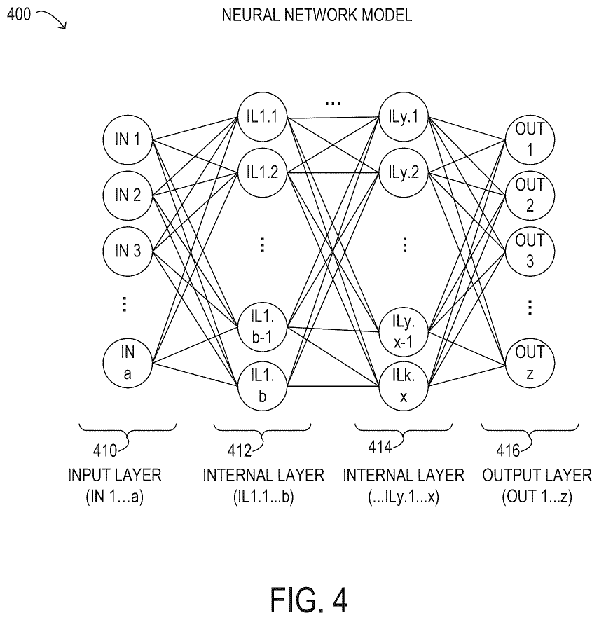

Accordingly, as shown in FIG. 1, RDU system 110 may be capable of operation using the various software components and tools installed at host 102 for controlling and managing RDU system 110. In particular, RDU system 110 may serve as an acceleration platform for executing workloads involving parallel data processing, and in particular, for AI/ML workloads. In various embodiments, AI/ML workloads can include training or inference of a NN model (see also FIG. 4), such as an LLM. Because RDU system 110 does not include various components and associated functionality typically included in a CPU, such as an instruction pipeline and clock, RDU system 110 may be specifically implemented for high-speed processing of AI/ML workloads. Furthermore, RDU system 110 may be capable of operating with lower power consumption for a comparable workload as a CPU or combined CPU/GPU systems, and in particular, for AI/ML workloads.

As depicted in FIG. 1, system interconnect 104 can be a primary or unitary connection for communication between host 102 and RDU system 110. In particular embodiments, system interconnect 104 can include a standard interface, such as a peripheral interconnect, an optical interconnect, or a network connection. For example, system interconnect 104 can represent a peripheral interconnect that is compatible with a peripheral component interconnect (PCI) bus standard. In some embodiments, system interconnect 104 can represent a network connection that is compatible with an Ethernet network standard. Furthermore, in particular embodiments, a total data processing throughput capacity of RDU system 110 can be determined based on a data throughput capacity of system interconnect 104 when system interconnect 104 is a singular connection to host 102. In other embodiments, system interconnect 104 can represent multiple parallel connections between host 102 and RDU system 110 that are bundled for increased throughput capacity. Accordingly, in different embodiments, host 102 can be configured to support various implementations of RDU system 110, such as different RDU systems 110 that are dimensioned with different numbers of components and having different overall data processing capacity.

As shown in FIG. 1, system interconnect 104 is communicatively coupled with local interconnect 116 that is used for various internal connections at RDU system 110. In some embodiments, system interconnect 104 and local interconnect 116 can include the same type of interface, such as a PCI bus standard, an optical bus standard, or an Ethernet network standard. In some embodiments, system interconnect 104 and local interconnect 116 can include different types of interfaces, such that a bridge or a bus multiplexer or similar interface conversion device is used between system interconnect 104 and local interconnect 116. Although depicted in FIG. 1 with a singular RDU system 110 having a certain number of internal components, system interconnect 104 may operate with (e.g., be coupled to) different numbers of RDU systems 110 or RDU systems having different numbers of internal components.

In FIG. 1, local interconnect 116 is shown branching to connect various internal components in RDU system 110. Specifically, RDU system 110 is shown including four (4) extensible RDU (xRDU) elements 112 that each include two (2) RDUs 114, of which xRDU element 112-1 having RDU 114-1 and RDU 114-2 are visible. In the exemplary embodiment of RDU system 110 in FIG. 1, xRDU elements 112-2, 112-3, and 112-4 can be identical to xRDU element 112-1. The branching of local interconnect 116 within RDU system 110 may be schematic to represent various bus topologies and distribution arrangements using corresponding additional equipment that is omitted from FIG. 1 for descriptive clarity. Furthermore, local interconnect 116 can further extend within RDU 114 to provide connections to various internal components of RDU 114, as described in further detail herein.

In particular embodiments, RDU system 110 may support so-called “on-board AI” in which an AI/ML model can be executed in the hardware included with RDU system 110 for acceleration of certain computational operations, such as linear algebra or matrix calculations. In particular, RDU system 110 can achieve acceleration factors of 1,000× or 10,000× or greater with respect to other types of processors. RDU system 110 can be specifically implemented to execute mathematical operations related to NN processing, such as linear algebra and tensor operations (including vector and matrix operations). In this manner, RDU system 110 can support large or very large AI/ML models that include NNs having 109 or more neurons with multiple NN layers for complex logic. RDU system 110 can be used, thus, for efficient execution of trained AI/ML models for on-board AI applications.

The linear algebra calculations performed by RDU system 110 can include multiply-accumulate calculations, calculation of bias weights, or calculations of activation functions that may involve relatively simple and repetitive calculations performed at large scale, such as for on-board AI. As noted, in particular implementations, the linear algebra calculations performed by RDU system 110 may be structured as matrix operations and can be executed using simplified compute units configured for parallel execution to improve acceleration, as will be described in further detail. In particular implementations, a large amount of memory can be included with or be accessible to RDU system 110, such as to support larger on-board AI applications, as will be described further below. Furthermore, to enhance acceleration, RDU system 110 may be implemented to support lower precision numerical values, such as involving a smaller number of bits per numerical value, for NN calculations. In particular embodiments, RDU system 110 can support integer values rather than floating point values for improved acceleration.

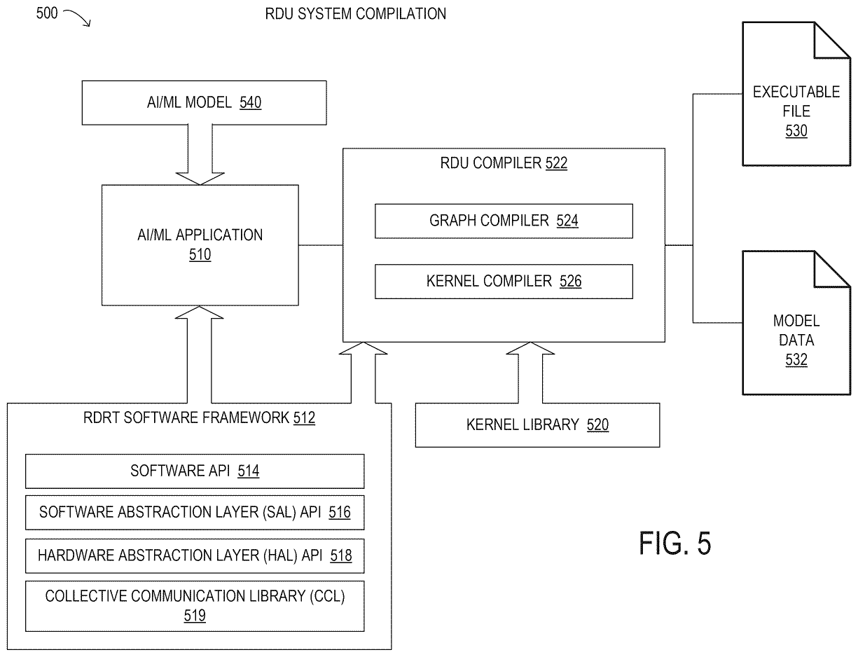

In operation of reconfigurable dataflow architecture 100, an application, such as an AI/ML application, can be prepared at host 102 for execution by RDU system 110. The functionality of the application along with data associated with the application can be configured at host 102 using software applications and tools installed on host 102 for operating RDU system 110. For example, the application can use application specific interface (API) function libraries for accessing hardware functionality within RDU system 110. The APIs may form part of a software framework that includes functions that can be called from the application to access a driver for RDU system 110, including functions executing in kernel mode in an operating system running on host 102. For example, an AI/ML application can be compiled using an RDU compiler 522 (see also FIG. 5) on host 102 to generate an executable file 530 having binary code that is specific to RDU 114, as will be described in further detail. The executable file 530, along with model data 532 that describes a NN for the AI/ML application in some embodiments, can be sent for execution to at least one RDU 114 via local interconnect 116. The output from the NN can then be transferred back to the AI/ML application at host 102 via local interconnect 116. In this manner, RDU system 110 can be used for accelerated execution of the AI/ML application in reconfigurable dataflow architecture 100. The term “reconfigurable” can be indicative of the ability to generate (e.g., compile) executable file 530 that configures hardware in RDU system 110 for executing a particular application (rather than compiling code for execution by a CPU), while the term “dataflow” can be indicative of a parallelized workload, such as the AI/ML application based on the NN, that is driven by input data to generate output data (rather than by a clocked instruction pipeline as in a CPU).

FIG. 2 illustrates a block diagram depiction of a high-performance computer (HPC) host 102-1. In some embodiments, host 102 (see FIG. 1) may be implemented using HPC host 102-1 shown including multiple modular computers 202-1, 202-2, 202-3, 202-4. Although four modular computers 202-1, 202-2, 202-3, 202-4 are shown in FIG. 2 for descriptive purposes, it is noted that any number of modular computers 202 may be used. In particular embodiments, a large number of modular computers 202 may be aggregated in HPC host 200 to provide greater computing capacity. Accordingly workloads, may be executed in a distributed manner in HPC host 200, by implementing multi-node application execution, such that multiple modular computers 202-1, 202-2, 202-3, 202-4 share processing of work tasks that may be performed in a parallel or simultaneous manner.

As shown in FIG. 2, HPC host 200 can be described in general terms as a collection of modular computers 202-1, 202-2, 202-3, 202-4 or any number of computers that respectively include a local processor and local memory and are interconnected by high-speed local network 222, which may be a dedicated high-bandwidth, low-latency network. HPC host 200 can accordingly aggregate and combine the computational power of multiple modular computers 202-1, 202-2, 202-3, 202-4, or any number of modular computers, to perform large-scale work tasks. HPC host 200 can flexibly scale HPC resources that can be matched to desired work tasks. HPC host 200 can also provide configuration for work task parallelization, data distribution, parallel execution, host monitoring and control, as well as supporting parallelized computations having combined output. Various software applications can execute on HPC host 200 in a local or distributed manner, such as on a single modular computer 202-1 or on multiple modular computers with the addition of modular computers 202-2, 202-3, 202-4, or another number of modular computers.

As shown in FIG. 2, HPC host 200 is shown including a memory 240, which may represent one or more memory devices that are compatible with high-speed local network 222. High-speed local network 222 may be a dedicated local bus such as including InfiniBand, 40 Gb Ethernet, or PCIe. Accordingly, memory 240 can provide access to storage resources using low latency high-speed local network 222 to support work tasks handled by HPC host 200. It is further noted that HPC host 200 may include a dedicated network interface that can provide network connectivity by using modular computers 202-1, 202-2, 202-3, 202-4, or another number of modular computers.

In particular embodiments, modular computer 202 in HPC host 102-1 can be an instance of computer system host 102-2 (see FIG. 3) that includes a peripheral bus 342 for use with system interconnect 104 (see FIG. 1). In some embodiments, high-speed local network 222 can be coupled for use with system interconnect 104. In particular, memory 240 is shown storing an application 204 that can be executed, at least in part, using RDU system 110, as described herein with respect to architecture 100.

FIG. 3 illustrates a block diagram depiction of a computer system host 102-2, in accordance with one or more embodiments of this disclosure. Embodiments described herein may be implemented using a computer system, such as computer system host 102-2, in an individual manner or in a cluster of multiple computer systems. Accordingly, computer system host 102-2 may represent any of a variety of computing devices, such as, but not limited to personal computers, desktop computers, laptops, tablets, mobile devices, smart phones, cloud servers, blade computers, microcomputers, embedded devices, or modular computers, among others.

As shown in FIG. 3, computer system host 102-2 includes a processor subsystem 320, a local system bus 322 for interconnecting various local elements, a memory 330, an operating system (OS) 332, an input/output (I/O) subsystem 340, a local storage resource 350, a network interface 360, and network 120.

As shown in FIG. 3, processor subsystem 320 may include an integrated circuit (IC), such as in the form of a semiconductor device that is formed using at least one substrate, such as silicon. Processor subsystem 320 may accordingly be used for interpreting and executing program instructions and processing data that is stored either locally or remotely or both. Processor subsystem 320 may include a central processing unit (CPU) that uses an instruction set architecture to execute instructions, such as, but not limited to an advanced reduced instruction set computer (RISC) machine (ARM) architecture or an x86 architecture.

As shown in FIG. 3, a local system bus 322 may represent a variety of suitable types of bus structures, such as but not limited to a memory bus, a data bus, an address bus, a control bus, or a peripheral bus, among various other examples.

As shown in FIG. 3, memory 330 may include a system, device, or apparatus operable to retain and retrieve processor-executable instructions or data or both, such as for a period of time. Memory 330 may include volatile memory such as RAM, including video RAM (VRAM), static RAM (SRAM), or dynamic RAM (DRAM), cache memory, and non-volatile memory. Memory 330 may include or represent a computer-readable non-transitory medium that includes, but is not limited to portable or non-portable storage devices, optical storage devices, magnetic storage devices, or various other storage media. The processor-executable instructions may include a procedure, a function, a subprogram, a program, a routine, a subroutine, a module, a software package, a data object, a data structure, or a program statement, or various combinations thereof.

As shown in FIG. 3, an OS 332 is stored in memory 330. OS 332 may represent an execution environment for various program code executing on computer system host 102-2. OS 332 may be any of a variety of standard or customized operating systems, such as but not limited to a Microsoft Windows® operating systems, a UNIX or a UNIX-based operating system, a mobile device operating system, an Apple® MacOS or iOS operating system, an embedded operating system, or a hypervisor for executing multiple virtual machines on common hardware, among others. OS 332 can be an operating system that supports shared memory, distributed memory, virtual memory, contiguous or non-contiguous memory allocation, among other memory arrangements. Also shown included with memory 330 is application 204 described above with respect to FIG. 2 and that can represent an AI/ML application for execution on RDU system 110, as described herein.

As shown in FIG. 3, in computer system host 102-2, I/O subsystem 340 may include a system, device, or apparatus generally operable to receive/transmit data to or from or internally within computer system host 102-2. In different embodiments, I/O subsystem 340 may be used to support various peripheral devices or interfaces. I/O subsystem 340 may represent a variety of communication interfaces such as, but not limited to, graphics interfaces, video interfaces, user input interfaces, and peripheral interfaces. I/O subsystem 340 may support various output or display devices, such as but not limited to a screen, a monitor, a general display device, a liquid crystal display (LCD), a plasma display, a touchscreen, a projector, a printer, an external storage device. In particular, I/O subsystem 340 is shown providing peripheral bus 342 that can support system interconnect 104, as described above with respect to FIG. 1.

As shown in FIG. 3, local storage resource 350 may comprise non-volatile or persistent computer-readable media such as a hard disk drive, CD-ROM, and other type of rotating storage media, flash memory, electrically erasable programmable read-only memory (EEPROM), or another type of storage media, and may be generally operable to store instructions and data and to permit access to stored instructions and data on demand. Local storage resource 350 may include a storage appliance or a storage subsystem having one or more arrays of storage devices such as for supporting redundancy, mirroring, or real-time data error correction and restoration.

As shown in FIG. 3, network interface 360 may facilitate connecting computer system host 102-2 to network 120. Network 120 may represent various configurations, such as but not limited to a local area network (LAN), a wide area network (WAN) such as the Internet, or a mobile network, such as a wireless network. Network interface 360 may accordingly include or support wireless networks or wired networks. The wired network media supported by network interface 360 (or included in I/O subsystem 340) may include analog media, universal serial bus (USB), Apple® Lightning®, Ethernet, peripheral connect interface express (PCIe), DisplayPort (DP), Thunderbolt, fiber optics, a proprietary wired media, or an ad-hoc network media, among others. The wireless network media supported by network interface 360 may include or support visible light communication (VLC), worldwide interoperability for microwave access (WiMAX), a Bluetooth® wireless signal transfer, an IBEACON® wireless signal transfer, an radio-frequency identification (RFID) wireless signal transfer, near-field communications (NFC) wireless signal transfer, dedicated short range communication (DSRC) wireless signal transfer, 802.11 WiFi wireless signal transfer, wireless local area network (WLAN) signal transfer, infrared (IR) communication wireless signal transfer, global navigation satellite system (GNSS), global system for mobile communication (GSM), such as 3G/4G/5G/LTE cellular data network wireless signal transfer, radio wave signal transfer, microwave signal transfer, infrared signal transfer, visible light signal transfer, ultraviolet light signal transfer, or more generally, various kinds of wireless signal transfer along using radiation in a wavelength range of the electromagnetic spectrum.

FIG. 4 depicts an NN model 400 in one embodiment. NN model 400 is depicted as a neural network architecture having an input layer 410, internal layers 412, 414, and an output layer 416. In particular embodiments, implementation and use of NN model 400 may be performed using RDU system 110, as described herein. For example, executable file 530 can be compiled to configure and operate RDU system 110 to implement NN model 400 in various embodiments. In some embodiments, model data 532 can also be sent to RDU system 110 for this purpose (see FIG. 5).

In the mathematical processing of NN model 400 of FIG. 4, the processing at each layer can be represented by an activation function that can be generalized by Equation 1.

$$y = {\sum }_{i} ( {w}_{i} {x}_{i} ) + b \qquad Equation 1$$

In Equation 1, y is an output value, i represents an index variable or dimension for each layer input, such as a, b. x, and z in FIG. 4; xᵢ represents the input value at each neuron, such as from another neuron; Wᵢ represents a weighting coefficient applied at each neuron; and b represents a constant for each neuron. The output of each neuron can be represented by output value y of Equation 1, among other parameters in particular embodiments.

The process of activation of each internal layer as described above and illustrated in FIG. 4 is generally known as feedforward activation, which characterizes the typical use of a neural network to receive input and generate output. Feedforward may occur over multiple timesteps and may involve the use of externally generated data that are referred to as “tokens”, internally generated data, or both. The use of feedforward activation within NN model 400 to generate output (separate from feedback, backpropagation, and other types of training) is also known as “inference”.

It is noted that although NN model 400 is depicted with a certain set of nodes or artificial neurons (referred to herein as simply “neurons”) in FIG. 4, the dimensionality and structure of NN model 400 can be adapted for various specific types of data and applications. For example, as shown, NN model 400 can be expanded to a number of input neurons, w number of input layers each having b through x number of neurons respectively, and z number of output neurons. It is noted that a, b through x, w, and z can each have different dimensions, such as 103, 106, 109, 1012, among other values in various embodiments. Furthermore, although a single network is shown with NN model 400 in FIG. 4, it is noted that in different implementations, NN model 400 can be structured to incorporate different numbers of networks, such as by implementing a branched or otherwise structured topology.

In order to implement NN model 400 for a given useful application, a training process can be employed to determine respective weighting coefficients applied at each neuron, such as using Equation 1 or another activation function. For example, weighting coefficients associated with neurons in NN model 400 can be represented as a 2-D tensor (e.g., a matrix) that are included in model data 532 as explained in further detail below.

In the field of NNs and ML, optimization algorithms can be useful for training models by minimizing the error between the predicted output and target values. One known class of optimization algorithms are gradient descent algorithms. Gradient descent can be an iterative optimization algorithm used to minimize a “cost function” (also referred to as a “loss function”), which quantifies an error or a difference between an ML model's prediction and a target value (e.g., a known reference value). The gradient descent can operate by adjusting the parameters of the NN to reduce the error over multiple iterations.

To identify a direction and a magnitude by which model parameters are to be updated, gradients represented by partial derivative of a given model parameter with respect to the cost function, can be computed. For typical feedforward NNs, as shown in NN model 400, the computation of the gradients can be done using so called “backpropagation”, which involves a reverse application of a chain rule to propagate the gradient of the loss function backwards through the NN. In particular embodiments, backpropagation may be used to iteratively train NN model 400, such as by using RDU system 110. For example, the calculated output of NN model 400 may be represented by output data while the reference output may be represented by validation data. The backpropagation method may begin with output layer 416 and then iterate in a reverse manner over internal layer 414, then internal layer 412, to finally arrive at input layer 410.

Because most useful NN models have large numbers of inputs and outputs, backpropagation can be resource-intensive. While the calculation of the cost function itself can be relatively simple and fast, calculation of the gradients with respect to the cost function is generally more resource intensive. For some NN models, the runtime of each backpropagation for training may be greater than the feedforward activation for inference. Accordingly, reconfigurable data flow architecture 100 shown in FIG. 1, and as described herein, can provide acceleration of computations, such as in backpropagation for training or feedforward activation for training, which is desirable.

FIG. 5 is a block diagram of an RDU system compilation 500, in one embodiment. FIG. 5 is a schematic illustration of a process describing RDU system compilation 500, in one exemplary embodiment. It is noted that various other elements or different arrangements of RDU system compilation 500 can be used or performed in different embodiments.

As shown in FIG. 5, RDU system compilation 500 includes an AI/ML application 510 and an RDU compiler 522 that can represent different software applications capable of execution on host 102. In particular, AI/ML application 510 and RDU compiler 522 can be executed in a host user space 601 within an operating system executing on host 102, such as OS 332 (see also FIGS. 3 and 6). AI/ML application 510 can represent at least some software functionality defined by a user of reconfigurable data flow architecture 100 for execution using RDU system 110. For example, AI/ML application may be developed or programmed by the user (or on behalf of the user) using various tools and software routines, as noted above. Specifically, API function libraries for accessing hardware functionality within RDU system 110 can be provided as an RDRT software framework 512. The functions in API function libraries of RDRT software framework 512 can be integrated into the code of AI/ML application 510 or RDU compiler 522, as shown in FIG. 5, to provide runtime access to commensurate functionality performed by an RDRT driver 620 executing in a host kernel space 602 (see FIG. 6) within the operating system executing on host 102.

In FIGS. 5 and 6, various external function libraries and data structures are shown with arrowed boxes indicating contribution of code elements directed to a software application. For example, the code elements, such as API function libraries, can be integrated into the software element during development or programming, and then can be compiled into an executable form of the application. In some cases, code elements can be added or integrated as options or features in an application level tool.

In FIG. 5, an AI/ML model 540 and RDRT software framework 512 are shown contributing to the source code of AI/ML application 510 in this manner. Specifically, AI/ML model 540 may represent a NN-based model, such as an LLM, that the user of reconfigurable dataflow architecture 100 seeks to implement and run using RDU system 110, and for which purpose AI/ML application 510 is developed, including specific support for hardware features of RDU system 110. Accordingly, AI/ML model 540 can be provided by the user, or on behalf of the user, in various embodiments. It is noted that AI/ML model 540 may represent a local or remote source of data describing or defining the NN-based model, such as NN model 400 (see FIG. 4), which may be defined using a 2-D tensor of weighting coefficients (Wᵢ), for example, among other values.

As shown in FIG. 5, RDRT software framework 512 comprises various API function libraries, including a software API 514, a software abstraction layer (SAL) API 516, a hardware abstraction layer (HAL) API 518, and a collective communication library (CCL) 519. The API function libraries (514, 516, 518, 519) included with RDRT software framework 512 can define a so-called “application stack” using the system-level function libraries that allow the user to run AI/ML model 540 on RDU system 110. The application stack can accordingly be implemented for a specific user application as AI/ML application 510. In particular, CCL 519 can be used for orchestration and coordination of the data-parallel execution of AI/ML model 540 using RDU system 110. In particular, CCL 519 can support non-blocking and standard-mode blocking of P2P communications among RDUs 114, persistent communication requests, as well as allowing AI/ML application 510 to directly access device memory on RDU 114, for example, to eliminate a redundant copy of memory contents at host 102. In particular, CCL 519 may provide a transport layer that supports different interfaces for system interconnect 104, such as to accelerate memory transfers between different RDUs 114, such as by supporting remote direct memory access (RDMA). For example, CCL 519 may support or select among various available interfaces, such as PCIe, RDMA over Converged Ethernet (RoCE), or InfiniBand, among others.

Also in RDU system compilation 500 is RDU compiler 522 that represents another software tool executable at host 102 to generate executable file 530 and model data 532 that are compiled into a format that is specific for RDU system 110. In particular, executable file 530 and model data 532 can be used to execute AI/ML model 540 on RDU system 110, as also defined or specified by AI/ML application 510. In some embodiments, such as when using RDU system 110 to implement externally developed AI/ML models, external model data instead of model data 532 can be used. In particular embodiments, RDU compiler 522 can itself be comprised of functional libraries and routines that are invoked using RDRT software framework 512 as a development environment for implementing AI/ML model 540. In various embodiments, RDRT software framework 512 can also be used to develop AI/ML application 510. Accordingly, RDRT software framework 512 can perform model graph tracing, invoking RDU compiler 522, and orchestrating execution of AI/ML model 540. A selection of RDRT software framework 512 can depend on a hardware or operating system environment used for host 102. Some examples of software platforms that can be used for RDRT software framework 512 include PyTorch or TensorFlow, among others.

As shown in FIG. 5, a kernel library 520 may include a set of operator kernels that supports both a graph compiler 524 a kernel compiler 526 that comprise RDU compiler 522. In particular, kernel library 520 can be specifically optimized for RDU system 110. Graph compiler 524 may be responsible for model-level graph transformation and various optimizations in this regard. For example, graph compiler 524 may transform or convert a model graph of AI/ML model 540 into compiled RDU kernel graphs and execution schedules included with model data 532 for execution on RDU system 110. Similarly, kernel compiler 526 may transform the RDU kernel graphs into executable file 530 that is specific for RDU system 110 as the execution target.

FIG. 6 is a block diagram of an RDRT architecture 600, in one embodiment. FIG. 6 is a schematic illustration of a post-compilation runtime process for executing AI/ML model 540, represented in FIG. 6 by executable file 530 and a model data 632, on RDU system 110 in one exemplary embodiment. It is noted that various other elements or different arrangements of RDRT architecture 600 can be used in different embodiments.

In FIG. 6, RDRT architecture 600 comprises an RDRT supervisor 610, AI/ML application 510, and RDRT software framework 512 that are software applications or modules that may be executed in host user space 601 on host 102. RDRT architecture 600 also comprises an RDRT driver 620 that may be executed as a kernel service in host kernel space 602 on host 102. RDRT driver 620 is further shown as a logical endpoint of system interconnect 104 to RDU system 110. RDRT driver 620 may control and manage system interconnect 104, including managing a host memory space associated with system interconnect 104 as well as direct memory access (DMA) transfers via system interconnect 104. In various embodiments, RDRT software supervisor 610 may directly communicate with RDU system 110 such as for various hardware and software configuration purposes. Accordingly, as given in RDRT architecture 600, RDRT driver 620 and RDRT supervisor 610 may perform or enable various tasks associated with configuring and executing executable file 530 and model data 632 on RDU system 110.

In some embodiments, at least certain portions of RDRT driver 620 (or an equivalent module) may be executed in host user space 601, instead of host kernel space 602. For example, a kernel driver for system interconnect 104 may be used, such that other functionality shown with RDRT driver 620 can operate in host user space 601.

As shown in FIG. 6, model data 632 can represent model data 532 generated by RDU compiler 522, or external model data from an external source in some embodiments. For example, RDRT software framework 512 may provide a graph finite state machine (FSM) and handle data transfer to RDU system 110. Additionally, RDRT supervisor 610 may access control/status registers (CSR) on RDU system 110 to interact with, monitor, and control various actions, such as by reading or writing a particular CSR for a particular purpose.

As shown in FIG. 6, RDRT driver 620 includes various modules including a resource manager 622, a scheduler 624, an RDU abstraction layer 626, and an RDU interrupt handler 628. Resource manager 622 may coordinate and allocate hardware resources on RDU system 110 with respect to workloads for a given AI/ML application 510. Scheduler 624 may represent software-based scheduling of processing tasks on RDU system 110 (in contrast to local hardware scheduling in RDU system 110).

In FIG. 6, RDRT supervisor 610 can be a user operated application that handles fault management and initialization during runtime, among other tasks, on RDU system 110. Accordingly, RDRT supervisor 610 is shown including RDRT management 614 that can integrate functions and features from management API and external access API 612 for the user, among other monitoring and control functions for RDU system 110. RDRT management 614 can accordingly be used to programmatically request information about RDU status, manage RDUs, and retrieve information about host 102. RDRT fault management 616 includes a framework that supports reporting, diagnosing, and analyzing system error and fault events associated with RDU system 110, including reporting, logging, and clearing faults, among other actions. RDRT initialization 618 includes functionality for initializing hardware components in RDU system 110 prior to runtime, such as upon startup, in order to place the hardware components in a desired operational state or condition. RDU interrupt handler 628 may include subroutines that can be triggered in response to one or more interrupts that are generated by RDU 114. For example, RDU interrupt handler 628 may report interrupts to RDRT supervisor 610 for further handling and processing.

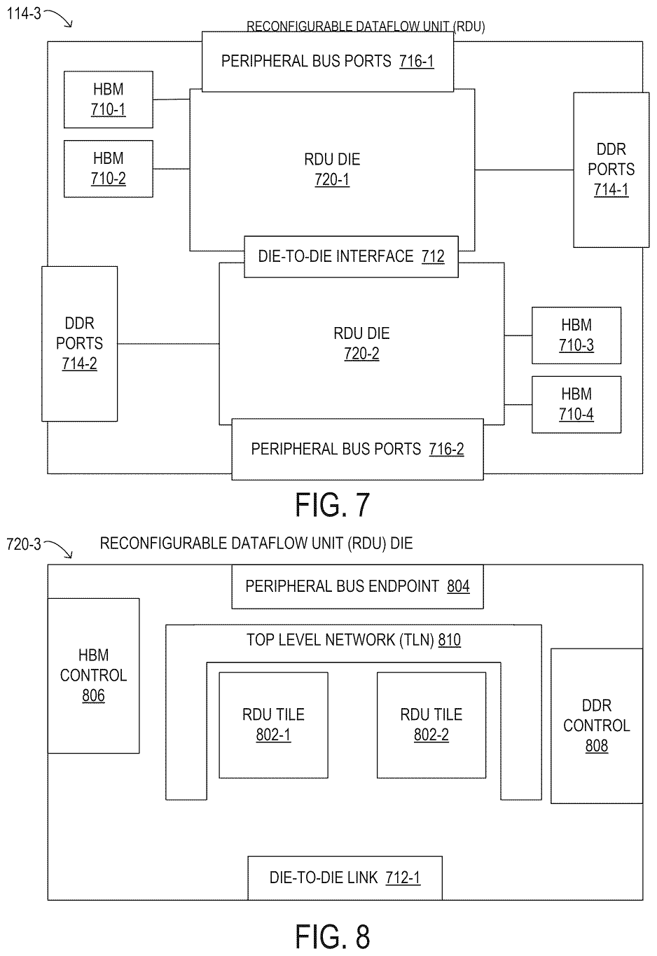

In FIGS. 7, 8, and 9, various internal components of RDU 114 included with xRDU element 112 are shown (see FIG. 1). FIGS. 7, 8, and 9 are schematic illustrations and are not necessarily drawn to scale or perspective. It is also noted that in FIGS. 7, 8, and 9, various components are depicted and described below, while various other details, such as connection traces, power routing elements, and various circuit details are omitted for descriptive clarity. In particular, various communication links that provide communicative and signaling functionality among depicted components in FIGS. 7, 8, and 9 are omitted for descriptive clarity. In some embodiments, different components can be included with RDU 114 than depicted in the exemplary embodiments of FIGS. 7, 8, and 9 presented for descriptive purposes.

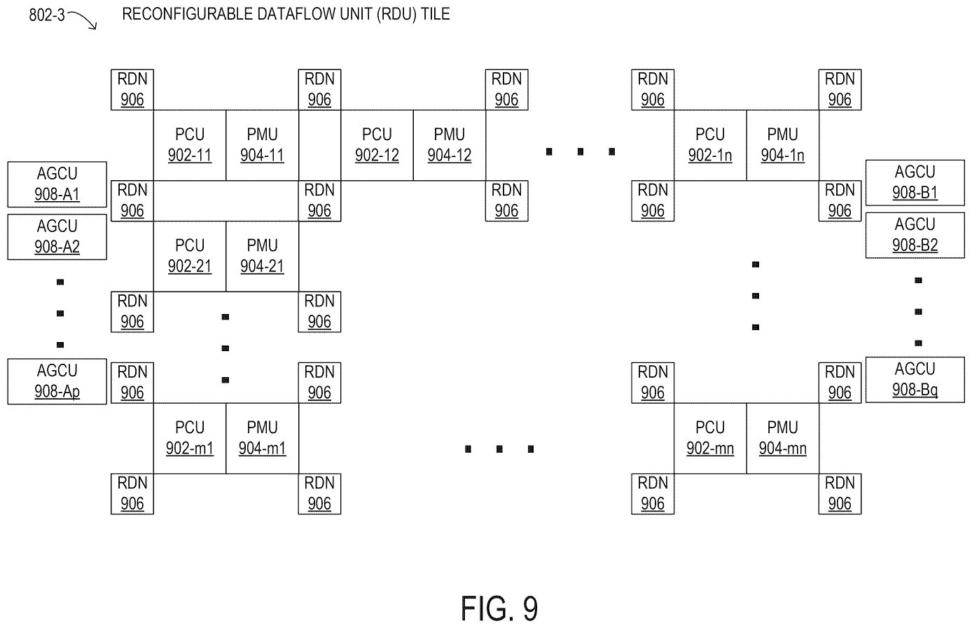

As noted above, in the exemplary embodiment of reconfigurable dataflow architecture 100 in FIG. 1, xRDU element 112-1 is depicted as being populated with two (2) RDUs 114-1, 114-2, each of which being coupled to local interconnect 116. It is noted that the arrangement depicted in FIG. 1 is an example for descriptive purposes and that different numbers of RDUs 114 may be integrated into xRDU element 112 in different embodiments. FIG. 7 depicts an exemplary embodiment of RDU 114-3; FIG. 8 depicts an exemplary embodiment of an RDU die 720-3; FIG. 9 depicts an exemplary embodiment of an RDU tile 802-3.

FIG. 7 is a block diagram of RDU 114-3, in one embodiment. In particular embodiments, RDU 114-3 can be packaged as a dual die socket using chip-on-wafer-on-substrate (CoWoS) multi-chip packaging. As shown, RDU 114-3 includes two RDU die 720-1, 720-2 that are coupled together with a die-to-die (D2D) interface 712. RDU 114-3 also includes two banks of peripheral bus ports 716 that provide various internal and external connections for each RDU die 720, respectively. Specifically, peripheral bus port 716-1 is accessible to RDU die 720-1, while peripheral bus port 716-2 is accessible to RDU die 720-2. In some embodiments, peripheral bus port 716 can provide a host interface via local interconnect 116, as well as multiple internal peer-to-peer (P2P) links to other RDUs 114 in RDU system 110. The host interface at peripheral bus port 716 can be coupled to, or form a portion of local interconnect 116 (see FIG. 1) and further be coupled to host 102 via system interconnect 104. In this manner, system interconnect 104 and local interconnect 116 can provide direct memory access (DMA) over the host interface between host memory (such as memory 330, see FIG. 3) and HBM 710 or DDR memory (not shown), as well as direct communication between host 102 and RDU tile 802. Additionally, each RDU die 720 is coupled to two (2) high bandwidth memories (HBM) 710 and at least one double data rate (DDR) memory port 714 that supports external DDR memory (not shown). Specifically, RDU die 720-1 is coupled to HBM 710-1 and HBM 710-2, along with DDR memory ports 714-1, while RDU die 720-2 is coupled to HBM 710-3 and HBM 710-4, along with DDR memory ports 714-2. As will be described in further detail, RDU die 720 includes multiple pattern compute units (PCU) 902 and pattern memory units (PMU) 904 (see FIG. 9) for executing parallelized workloads.

Accordingly, a three tier memory architecture implemented in RDU 114-3 includes PMU 904 (not visible in FIG. 7, see FIG. 9), HBM 710, and DDR memory ports 714, which is desirable. In particular embodiments, HBM 710 can have a capacity of 64 GB with a throughput bandwidth of at least 1.8 TB/s, while DDR memory port 714 can support a capacity of 1.5 TB with a throughput bandwidth of at least 200 GB/s. In particular embodiments, HBM 710 and DDR memory port 714 can be managed by software, such as by using RDRT driver 620 at host 102.

FIG. 8 is a block diagram of RDU die 720-3, in one embodiment. As shown, RDU die 720-3 includes a peripheral bus endpoint 804 that can represent an endpoint of peripheral bus ports 716. RDU die 720-3 also includes D2D interface 712-1 that represents one endpoint of D2D interface 712. D2D interface 712 can enable components in RDU tile 802 to stream data between two RDU die 720, such as between RDU die 720-1 and 720-2 in FIG. 7, in a direct manner that may be independent of external memory, such as HBM 710 and DDR memory (not shown). RDU die 720-3 is further shown including an HBM control 806 for interfacing to HBM 710, as well as DDR control 808 for interfacing with DDR memory ports 714 that support external DDR memory (not shown).

In FIG. 8, RDU die 720-3 is also shown including two (2) RDU tiles 802 that represent dataflow cores performing the core computing operations in RDU system 110, and further include an array of PCUs 902 and PMUs 904, described in further detail below with respect to FIG. 9. Specifically, RDU tile 802-1 and RDU tile 802-2 are provided with a top-level network (TLN) 810 that interfaces with RDU tiles 802 and handle parallelized data throughput to and from RDU tiles 802, such as between RDU tile 802 and host 102, HBM 710, DDR memory ports 714, as well as P2P links to other RDUs 114 via peripheral bus ports 716.

FIG. 9 is a block diagram of RDU tile 802-3, in one embodiment. In particular embodiments, as shown in FIG. 8, RDU die 720 includes two (2) RDU tiles 802. However, in various implementations, different number of RDU tiles 802 can be included in RDU die 720. In FIG. 9, RDU tile 802-3 may represent a coarse-grained reconfigurable array (CGRA) of dataflow cores that each include a pattern compute unit (PCU) 902 coupled with a pattern memory unit (PMU) 904. In addition to PCUs 902/PMUs 904, RDU tile 802-3 includes multiple address generation and coalescing units (AGCUs) 908 that may be connected together in a two-dimensional (2D) mesh interconnect, referred to as a reconfigurable dataflow network (RDN) 906.

Specifically, as shown in FIG. 9, the array of dataflow cores is shown comprising the 2D mesh array in RDU tile 802-3 is comprised of array elements having one PCU 902 coupled with one PMU 904. In FIG. 9, RDU tile 802-3 is shown having a first array element PCU 902-11/PMU 904-11 at a top left corner. A first row of array elements in RDU tile 802-3 includes PCU 902-12/PMU 904-12 in a second column, and further array elements, up to PCU 903-1n/PMU 904-1n for n number of columns. A first column of array elements in RDU tile 802-3 includes PCU 902-21/PMU 904-21 in a second row, and further array elements, up to PCU 903-m1/PMU 904-m1 for m number of rows. A last array element in RDU tile 802-3 PCU 902-mn/PMU 904-mn is at a bottom right corner in FIG. 9. Also in RDU 802-3, RDN 906 is depicted as a plurality of switching elements at each corner of each individual array element that together represent the 2D mesh interconnect, where each RDN 906 switching element can connect to adjacent elements orthogonally and diagonally. Furthermore, the 2D mesh interconnect collectively represented by RDN 906 in FIG. 9 can connect externally to RDU tile 802-3 with TLN 810, as noted above.

In FIG. 9, AGCUs 908 are shown in two columns at the left and at the right. A first column is shown including AGCU 908-A1, AGCU 908-A2, up to AGCU 908-Ap for p number of AGCUs in the first column. A second column is shown including AGCU 908-B1, AGCU 908-B2, up to AGCU 908-Bq for q number of AGCUs in the second column. In particular embodiments, p and q can be different integers, or can be equal in some cases.

In operation of RDU tile 802-3, PCUs 902 can provide systolic and streaming compute capabilities. A datapath of PCUs 902 can include a header, a body, and a tail. The header of PCUs 902 can consume incoming dataflows and can drive the body. The body of PCUs 902 can be configurable as an output stationary systolic array or as a pipelined single-instruction-multiple-data (SIMD) core with multiple stages of vector compute. The tail of PCUs 902 can perform special element-wise functions and can populate a number of output first-in-first-out (FIFO) buffers included with PCU 902. The PCUs 902 datapath can accordingly perform efficient execution of general matrix multiply (GEMM) or similar operations, element-wise operations, or reductions.

In operation, PCUs 902 can function as either a 2D systolic array or as a SIMD core. The 2D systolic array can accelerate matrix multiplications, such as GEMM. Inputs to the 2D systolic array may be streamed left-to-right and top-to-bottom (as shown in FIG. 9) through a broadcast buffer. Accumulated results can be drained left-to-right to output FIFOs through the tail of PCUs 902. Matrix multiplication can be parallelized further across multiple PCUs 902. As a SIMD core, PCUs 902 can execute a parallel multidimensional tensor operation in a pipelined manner. Each SIMD stage can support common arithmetic, logical, and bit-wise operations in various numerical representations and precision, such as FP32, BF16, and INT32 formats. In addition, PCUs 902 can be optionally configured to implement a cross-lane reduction network. Lane-wise reductions can also be supported by PCUs 902 in a typical SIMD manner. PCUs 902 can include certain counters that track loop iterations and generate control events, such as when a counter reaches a programmed maximum value, indicating that a loop has completed execution, for example.

The tail of PCUs 902 can support transcendental functions, random number generation, stochastic rounding, and format conversions. An operation at the tail can be fused and pipelined with a compute operation in the body of PCUs 902. An operation can be parallelized across multiple PCUs 902 in a data parallel, tensor parallel, or pipeline parallel fashion. Data parallelism may be achieved by partitioning inputs and outputs to RDU tile 802 to create multiple independent data streams that can be processed by different PCUs 902. Tensor parallelism may be achieved by forking into data parallel streams, then joining such data parallel streams. Pipeline parallelism can be achieved by chaining multiple PCUs 902 together to fuse operations and increase operational intensity.

In RDU tile 802-3, PMUs 904 can provide on-chip memory capacity, throughput bandwidth, and addressing flexibility for efficient operator fusion. PMUs 904 an be used to store on-chip tensors like inputs, parameters, metadata, and intermediate results. In particular embodiments, PMU 904 can include the following components:
Scratchpad memory: Each PMU 904 may contain a programmer-managed scratchpad memory that can include a static random access memory (SRAM) array. The SRAM array used for the scratchpad memory may collectively support concurrent writes and reads.
Arithmetic logic unit (ALU) pipeline: PMU 904 may contain several stages of scalar integer ALUs that can be configured to generate read and write addresses concurrently to flexibly access a tensor in the scratchpad memory. PMU ALUs may implement a set of special complex instructions, such as bitfield extraction and shift-and-set, that may often be used in address computations. This instruction support may produce complex addresses efficiently and allow for reducing a number of ALU stages, thereby also reducing latency. The ALU pipeline can also include a path to ingest scalars as operands from RDN 906, and output computed values as scalars back to RDN 906. The ALU pipeline path can allow enhanced addressing composability. For example, complex integer calculations can be broken up and mapped across several PMUs 904 as desired. It has been observed that stage buffers in a spatially fused kernel involve concurrent reads and writes, which may have different access patterns. Certain intermittent scenarios have been observed in write and read access patterns for a tensor that inversely affect each access pattern's complexity (e.g., a relatively complex write access pattern often enables a relatively simpler read access pattern and vice versa). The ALU pipeline can allow software to exploit this observed behavior in write and read access patterns. For example, in some embodiments, the ALU pipeline can be partitioned into independent read and write address generation pipelines with a software-configured number of stages allocated to each type of access.
Address predication and banking: It has been shown that a single logical tensor can span multiple PMUs 904 due to capacity, throughput bandwidth, or both. PMU 904 can enable spanning a tensor over multiple PMUs 904 by providing hooks to programmatically control tensor address interleaving across PMUs. Specifically, PMU 904 can be programmed with a range of valid addresses for one instance of PMU 904. Alternatively, PMU 904 can support a programmable predicate bit per generated address. An address may accordingly be processed by PMU 904 if the address is within a programmed range or a valid predicate; otherwise the address may be dropped by PMU 904. Furthermore, addresses can be mapped to scratchpad banks using bank bit locations that can be programmed by software.
Data alignment unit: A data alignment unit in PMU 904 MAY support common tensor transformation operations, such as transpose, cross-lane vector permute, vector-unaligned accesses, lookup table (LUT), data format, and data layout conversions. Tensors to be transposed can be written in a special diagonally striped format across the scratchpad banks that enables reading the same tensor in both regular and transposed format at full bandwidth, which may allow for implementing the transpose operator as a read-write access pattern optimization between graph buffers.

As shown in FIG. 9, RDN 906 is a programmable interconnect on RDU tile 802 that facilitates communication between PCUs 902, PMUs 904, and AGCUs 908. RDN 906 can comprise three physical fabrics: a vector fabric, a scalar fabric, and a control fabric. The vector fabric and the scalar fabric can be packet-switched. The control fabric can be circuit-switched and can include a bundle of single bit wires that can be individually routed. The vector fabric can serve as a primary conduit for tensor data. The scalar fabric be used to transport metadata, such as an address, but in some cases can also be used to carry data or control signals. The control fabric can be used to carry control tokens for distributed coarse-grain flow control, and to collectively orchestrate the execution of a graph. Control tokens typically correspond to counter ‘done’ events that indicate the end of a loop. RDN 906 may be implemented using a mesh of non-blocking switches, as indicated by the blocks labeled RDN 906 in FIG. 9. Inbound scalar and vector packets to PCU 902/PMU 904 from RDN 906 may arrive via input FIFOs, and leave via output FIFOs. Transmissions on the vector fabric and the scalar fabric may be subject to credit-based flow control at every hop. Packet streams may also be subject to end-to-end flow control between communicating PCU 902/PMU 904 on RDN 906 through a combination of coarse-grained software tokens, fine-grained hardware credits, and forward progress guarantees in hardware. Routing tables for the vector fabric, the scalar fabric, and the control fabric may be configured by software using a place-and-route (PnR) layer within RDU compiler 522.

RDN 906 may support different types of communication patterns, including multi-cast and programmable routing and many-to-one and data reordering.
Multi-cast and programmable routing: Routing of packets on the scalar fabric and the vector fabric of RDN 906 can be done either dynamically using a 2-D dimension order route or as software-controlled static flow routing. In static flow routing, software assigns a flow ID field to a packet stream, which is carried with the packet. The flow ID field is decoded at every switch port and reassigned prior to forwarding the packet to its next destination. The static flow routing mechanism supports packet multi-casting through the switches of RDN 906.
Many-to-one and data reordering: Vector packets can contain a metadata field called sequence ID, which can be a mechanism to support arbitrary many-to-one streams in RDU tile 802. Vector output ports of PCU 902/PMU 904 can be equipped with programmable logic to generate sequence IDs for each output vector. In this manner, sequence IDs can be programmed by software to represent the logical vector order for a given operation across multiple sources. The sequence ID field can be used as an input operand in PMU 904 to compute the write addresses to reorder the packets.

As shown in FIG. 9, AGCU 908 can serve as a reconfigurable dataflow bridge for RDU tile 802 to access local device memory (HBM 710/DDR port 714), host memory 240/330, remote RDU device memory, and remote RDU tiles 802 via TLN 810. On the tile-side, AGCU 908 can operate as a dataflow core by exposing vector, scalar, and control ports of RDN 906. On the TLN-side, AGCU 908 can generate read and write requests and coalesce the responses. AGCU 908 may be equipped with a scalar address generation pipeline and counters, bearing some similarities to the logic of PMU 904, yet without having the SRAM of PMU 904. AGCU 908 can also provide an address translation layer for memory management.
P2P: AGCU 908 can support a P2P communication protocol to directly stream data between RDU tiles 802 on different instances of RDU 114 without involving DDR ports 714 or HBM 710. The P2P protocol can provide for building collective communication primitives between RDUs 114.
Kernel launch orchestration: AGCU 908 may implement a kernel launch mechanism that can include a sequence of three commands: Program Load, Argument Load, and Kernel Execute. Running a model may involves executing a schedule of kernel launches, which can be software-orchestrated or hardware-orchestrated. Software orchestration of the kernel launches may allow more flexible scheduling of kernels and can provide more host software visibility into model execution. However, software orchestration might incur overheads that can impact performance. Hardware orchestration offloads a static kernel schedule to the dedicated hardware in AGCUs 908, which can significantly reduce overhead but might be less flexible than software orchestration.

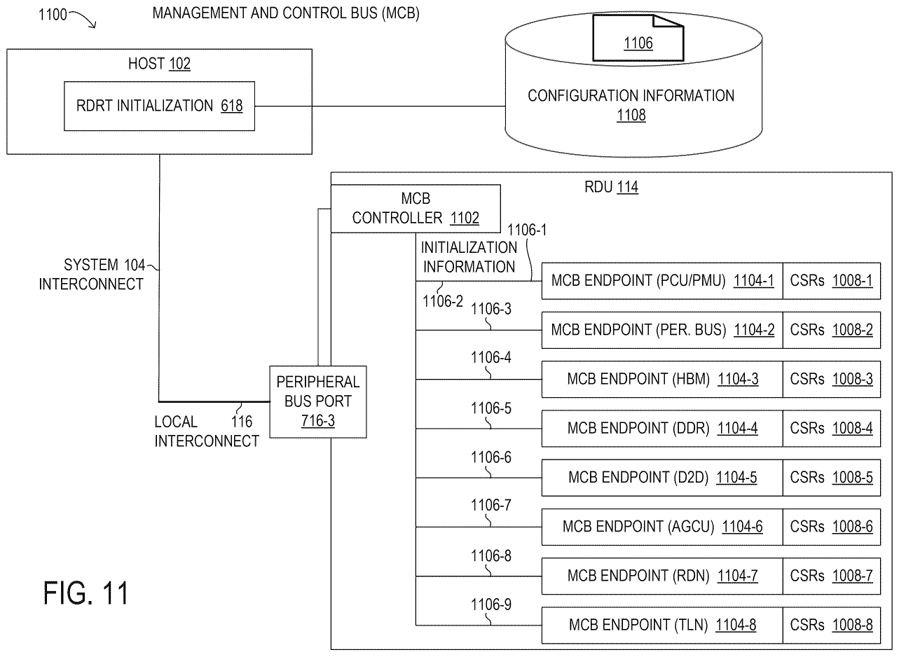

As noted, reconfigurable dataflow architecture 100, as described herein, can be used for component initialization and management of configuration information for hardware components included in RDU 114, among other components. In particular, RDRT supervisor 610 can maintain and manage configuration information 1108 (see FIG. 11) for various hardware components included in RDU system 110. Specifically, configuration information 1108 may be linked to RDRT supervisor 610 during compilation of RDRT supervisor 610 when RDRT supervisor 610 itself is programmed. For example, configuration information 1108, which may handle initialization for various different peripheral components, may be structured as a table or a list (or another data structure) that includes a function table for each respective hardware component, such as by individual type of each hardware component in RDU 114 that is supported Accordingly, configuration information 1108 may represent an extensible library of the function tables that can store and manage multiple different function tables to support multiple different peripheral components (or peripheral component types).

In particular embodiments, a function table can include at least one pointer that can link to respective firmware for a hardware component included in RDU 114 and supported by configuration information 1108. The respective firmware for the hardware component may control operation of the hardware component, and in particular, the initialization of the hardware component, such as to bring the hardware component in a desired startup state upon startup. Furthermore, the function table for each hardware component can itself be an extensible data structure, such that multiple function pointers respectively associated with different firmware elements, for example, can be linked to RDRT supervisor 610, for a given hardware component. In this manner, different hardware components included with RDU system 110 or RDU 114 can be independently managed without affecting each other. As used herein, “initialization information” refers to information stored in the function table in configuration information 1108 for a particular hardware component, such as the function pointers or the firmware itself, as well as related information or code associated with component initialization (see initialization information 1106 in FIG. 11).

In particular embodiments, configuration information 1108 or the function tables for specific hardware components in RDU system 110 or RDU 114 can be specifically populated with initialization information depending on a particular implementation of architecture 100, which can be designed and deployed with different processing capacity, such as compute capacity or memory capacity, among others. In some cases, the initialization information can depend upon specific types or versions of the hardware components that are used in RDU system 110 or RDU 114. In certain cases, the initialization information can depend upon a release version of specific firmware or other code being linked for a given hardware component. In various embodiments, the initialization information may include customized versions of the specific firmware or other code being linked for a given hardware component. Such customization can enable desired modifications to the initialization information, such as certain patches or bug fixes where indicated. In this manner, the use of configuration information 1108 and initialization information 1106, as disclosed herein for component initialization, can support specific implementations of architecture 100, such as different versions of hardware components, different generations of RDU system 110 or RDU 114, and different versions of firmware or other code being linked for a given hardware component.

In further embodiments, the use of configuration information 1108 and initialization information 1106, as disclosed herein for component initialization, can also support other efforts, such as research and development associated with RDU system 110 or RDU 114. For example, experimental versions of the initialization information can be used, such as for behavioral or functional testing purposes. Thus, even when the hardware components themselves are customized or are proprietary, configuration information 1108 and initialization information 1106, as disclosed herein for component initialization, can be used for component initialization.

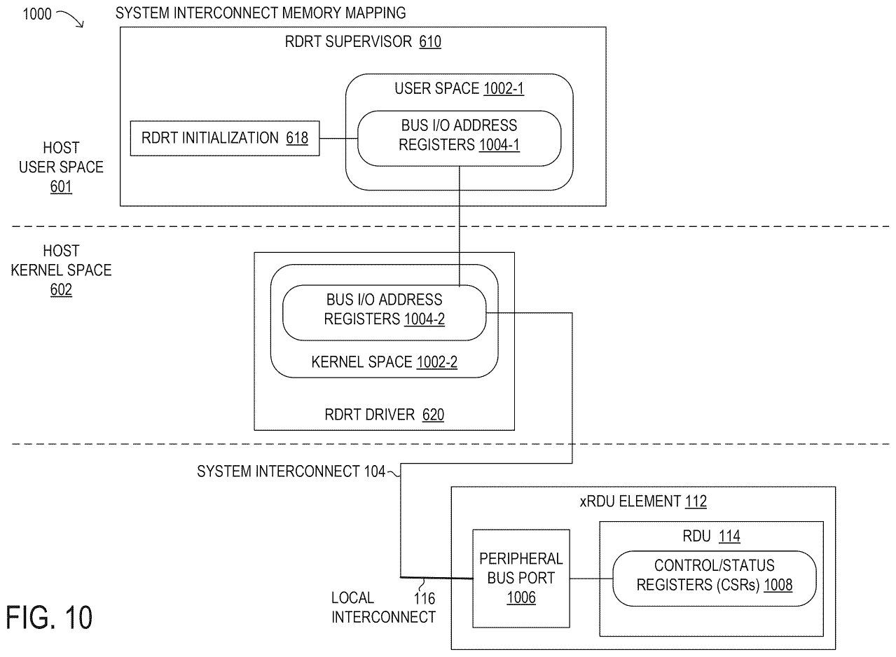

Turning now to FIG. 10, a block diagram of a system interconnect memory mapping 1000 is depicted, in one embodiment. FIG. 10 is a schematic illustration and is not necessarily drawn to scale or perspective. As shown in FIG. 10, system interconnect memory mapping 1000 depicts a user space 1002-1 and bus I/O address registers 1004-1 allocated and accessed by RDRT supervisor 610 that are executing in host user space 601. System interconnect memory mapping 1000 also depicts a kernel space 1002-2 and bus I/O address registers 1004-2 allocated and accessed by RDRT driver 620 (see also FIG. 6) that are executing in host kernel space 602. In FIG. 10, RDRT driver 620 may control system interconnect 104 to communicate with xRDU element 112 via local interconnect 116, in order to access control/status registers (CSRs) 1008 on RDU 114, such as via a peripheral bus port 1006 at xRDU element 112, for example. Also shown in system interconnect memory mapping 1000 is RDRT software framework 512 (see FIG. 5) executing in host user space 601.

In particular, as shown in FIG. 10, system interconnect memory mapping 1000 shows how RDRT supervisor 610 can access CSRs 1008 on RDU 114 for general purposes of management and control, and specifically for component initialization in reconfigurable dataflow architecture 100, as disclosed herein. CSRs, such as CSRs 1008, are additional digital registers typically used in ICs, such as processors or controllers, for reading status and setting configuration parameters. CSRs may thus be distinct from registers used for primary computation and processing and are typically mapped out and documented for purposes of programming a particular IC. As shown in FIG. 10, CSRs 1008 may represent different registers at different locations on RDU 114, such as for controlling various hardware components, for example, as shown and described with respect to FIG. 11 below.

As shown in FIG. 10, system interconnect memory mapping 1000 depicts a similar contextual view as RDRT architecture 600 in FIG. 6. In host user space 601, RDRT supervisor 610 is shown with RDRT initialization 618 that can allocate a user space 1002-1. User space 1002-1 includes bus I/O address registers 1004-1 that correspond to CSRs 1008 on RDU 114. In system interconnect memory mapping 1000, in host kernel space 602, RDRT driver 620 is shown allocating a kernel space 1002-2 that corresponds to user space 1002-1, and includes bus I/O address registers 1004-2 that correspond to bus I/O address registers 1004-1 and to CSRs 1008.

In operation of system interconnect memory mapping 1000, user space 1002-1 and kernel space 1002-2 (along with bus I/O address registers 1004-1 and 1004-2) may be mapped to an address space of system interconnect 104 and local interconnect 116. For example, when system interconnect 104 and local interconnect 116 are compatible with PCI, such as implemented as PCIe buses, bus I/O address registers 1004-1 and 1004-2 may correspond to I/O base address registers (BARs) (in contrast to memory BARs) that are mapped to corresponding CSRs 1008 in RDU 114. For example, CSRs 1008 can be mapped to a PCI BAR4 space within user space 1004-1 and kernel space 1002-2, in particular embodiments. Once CSRs 1008 have been mapped to a BAR space of system interconnect 104 and local interconnect 116, RDRT driver 620 can read and write bus I/O address registers 1004-2 to read and write CSRs 1008. Furthermore, in system interconnect memory mapping 1000, RDRT supervisor 610 can obtain information about kernel space 1002-2 from RDRT driver 620 to allocate and maintain user space 1002-1, including bus I/O address registers 1004-1. In this manner, RDRT initialization 618 can read and write bus I/O address registers 1004-1 in host user space 601 to read and write CSRs 1008 on RDU 114, as shown and described in further detail with respect to FIG. 11. For example, RDRT supervisor 610 may also access CSRs 1008 for certain aspects of component initialization using MCB 1100.

FIG. 11 is a block diagram of an MCB 1100, in one embodiment. FIG. 11 is a schematic illustration and is not necessarily drawn to scale or perspective. As shown in FIG. 11, MCB 1100 is depicted in the context of reconfigurable dataflow architecture 100 in FIG. 1 and as disclosed herein. Specifically, MCB 1100 is shown comprising an MCB controller 1102 and multiple MCB endpoints 1104 on RDU 114. MCB endpoints 1104 are depicted with corresponding CSRs 1008, in the exemplary embodiment of FIG. 11. In particular, MCB 1100 is shown in FIG. 11 and described below for the purpose of component initialization in architecture 100, as disclosed herein.

In various embodiments, MCB 1100 can represent various types of buses suitable for management and control of an IC and subcomponents of the IC. Accordingly, MCB 1100 can be a single-ended two-wire bus that transmits digital information serially, such as for low throughput bandwidth purposes of management and control, also sometimes referred to as “lightweight communication”. For example, MCB 1100 can be compatible with various types of I2C buses, such as System Management Bus (SMBus or SMB) that is commonly used with PCIe as an out-of-band management port. The single-ended architecture of MCB 1100 is depicted in FIG. 11 by having single MCB controller 1102 that can support MCB endpoints 1104, which serve as interfaces to MCB 1100. Although eight (8) specific endpoints on RDU 114 are depicted in FIG. 11 for descriptive clarity, RDU 114 can have additional endpoints or a large number of endpoints that are supported by MCB controller 1102. Furthermore, MCB endpoints 1104 are depicted schematically as interfaces associated with a given hardware component in FIG. 11 for descriptive clarity, as will be described in further detail below. In actual implementation, a routing and placement of bus lines between MCB controller 1102 and MCB endpoints 1104 may be at various suitable locations on RDU 114, such as corresponding to locations of associated hardware components.

In MCB 1100 in FIG. 11 for component initialization, configuration information 1108 may include initialization information 1106 for various hardware components included in RDU system 110 and RDU 114, as explained previously. Furthermore, RDRT initialization 618 can be configured to read and write CSRs 1008 as shown and described with respect to FIG. 10. A peripheral bus port 716-3 at RDU 114 (or at xRDU element 112, not shown in FIG. 11, see FIG. 1) may correspond to a host port to communicate with host 102. Configuration information 1108 is shown as a data repository that may be included with host 102 or may be externally accessible to host 102, such as a database. In some embodiments, at least certain content in configuration information 1108 can be accessible to host 102 via network 120.

In operation, RDRT initialization 618 may, at an appropriate time, such as upon startup of RDU 114, query configuration information 1108 for specific initialization information 1106 corresponding to hardware components on RDU 114. In some embodiments, RDRT initialization 618 may query and update initialization information 1106 on RDU 114 at every startup. In particular embodiments, RDRT initialization 618 may query and update initialization information 1106 on RDU 114 when indicated, such as when new initialization information 1106 is available, or when a hardware configuration of RDU 114 is modified from a prior startup, among other instances. In some embodiments, RDRT initialization 618 may query MCB controller 1102 to ascertain which MCB endpoints 1104 corresponding to which hardware components are indicated for updating initialization information 1106.

Then, RDRT initialization 618 may retrieve initialization information 1106 and may communicate with MCB controller 1102 to distribute respective initialization information 1106 on RDU 114. Specifically, a hardware component on RDU 114 may include a respective MCB endpoint 1104 that can be a logic block that implements a controller to manage the respective hardware component. The respective MCB endpoint 1104 may also be associated with respective CSRs 1008 for the hardware component, such as for enabling/disabling the hardware component, or for reprogramming the hardware component with initialization information 1106, for example, when initialization information 1106 includes firmware for the hardware component, such as firmware for the controller associated with the hardware component. RDRT initialization 618 can send initialization information 1106 to MCB controller 1102, which in turn, sends the initialization information 1106 to an MCB endpoint 1104 corresponding to the hardware component. MCB endpoint 1104 may include a controller for the respective hardware component, or may be in proximal communication with the controller.

As shown in FIG. 11, MCB controller 1102 may send initialization information 1106-1 and 1106-2 to MCB endpoint 1104-1 corresponding to PCU 902 and PMU 904 located at RDU tile 802, and CSRs 1008-1. MCB controller 1102 may send initialization information 1106-3 to MCB endpoint 1104-2 corresponding to peripheral bus ports 716 and CSRs 1008-2. MCB controller 1102 may send initialization information 1106-4 to MCB endpoint 1104-3 corresponding to HBM 710 and CSRs 1008-3. MCB controller 1102 may send initialization information 1106-5 to MCB endpoint 1104-4 corresponding to DDR ports 714 and CSRs 1008-4. MCB controller 1102 may send initialization information 1106-6 to MCB endpoint 1104-5 corresponding to D2D interface 712 and CSRs 1008-5. MCB controller 1102 may send initialization information 1106-7 to MCB endpoint 1104-6 corresponding to AGCU 908 and CSRs 1008-6. MCB controller 1102 may send initialization information 1106-8 to MCB endpoint 1104-7 corresponding to RDN 906 and CSRs 1008-7. MCB controller 1102 may send initialization information 1106-8 to MCB endpoint 1104-8 corresponding to TLN 810 and CSRs 1008-8. In various embodiments, additional hardware components can be sent initialization information in a similar manner as disclosed and described with respect to FIG. 11.

Subsequent to the sending of initialization information 1106 to respective hardware components, as described above, the respective hardware component can be in condition to use the initialization information 1106 to be initialized at startup and attain a desired operational state. For example, the controller associated with the hardware component along with certain CSR 1106 values, can update firmware for the hardware component upon receiving initialization information 1106.

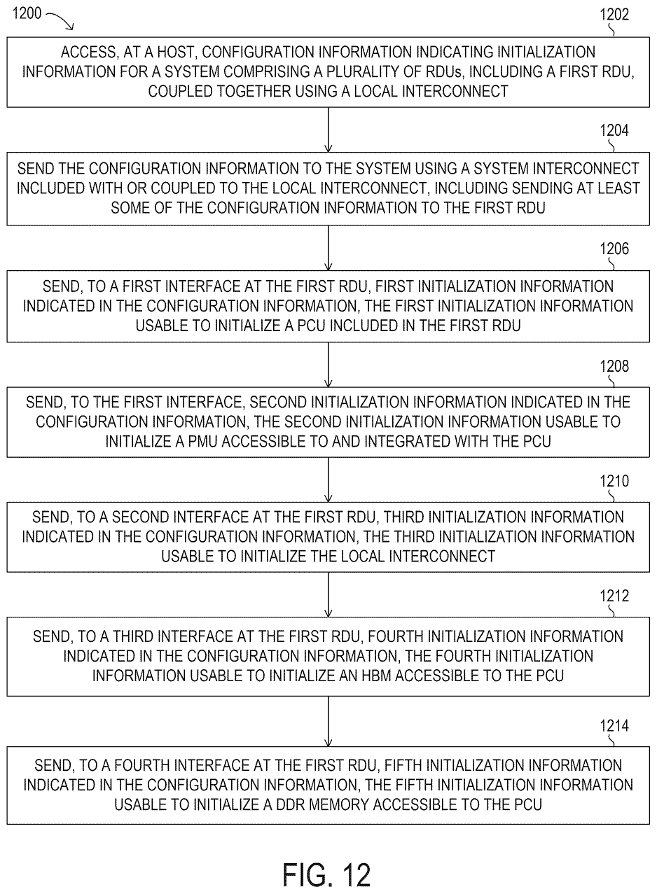

Referring now to FIG. 12, a flowchart of selected elements of an embodiment of a method 1200 for component initialization in reconfigurable dataflow architecture 100, as described herein, is depicted. Method 1200 may be performed using various hardware and software elements in reconfigurable dataflow architecture 100, as described above. In particular embodiments, at least certain portions of method 1200 may be performed using RDRT supervisor 610, such as by RDRT initialization 618 as described with respect to FIG. 11. It is noted that certain operations described in method 1200 may be optional or may be rearranged in different embodiments.

Method 1200 may begin at step 1202 by accessing, at a host, configuration information indicating initialization information for a system comprising a plurality of RDUs, including a first RDU, coupled together using a local interconnect. The “system” referred to in step 1202 and in method 1200 may be RDU system 110. At step 1204, the configuration information is sent to the system using a system interconnect included with or coupled to the local interconnect, including sending at least some of the configuration information to the first RDU. At step 1206, first initialization information indicated in the configuration information is sent to a first interface at the first RDU, the first initialization information usable to initialize a PCU included in the first RDU. At step 1208, second initialization information indicated in the configuration information is sent to the first interface, the second initialization information usable to initialize a PMU accessible to and integrated with the PCU. At step 1210, third initialization information indicated in the configuration information is sent to a second interface at the first RDU, the third initialization information usable to initialize the local interconnect. At step 1212, fourth initialization information indicated in the configuration information is sent to a third interface at the first RDU, the fourth initialization information usable to initialize an HBM accessible to the PCU. At step 1214, fifth initialization information indicated in the configuration information is sent to a fourth interface at the first RDU, the fifth initialization information usable to initialize a DDR memory accessible to the PCU.

As disclosed herein, a system includes a plurality of RDUs including a first RDU coupled together using a local interconnect. The first RDU includes a first interface to a PCU and a PMU accessible to and integrated with the PCU. The first RDUs is configured to receive configuration information via the local interconnect, while the configuration information indicates first initialization information usable to initialize the PCU via the first interface and second initialization information usable to initialize the PMU via the first interface.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system comprising:
a plurality of reconfigurable dataflow units (RDUs) including a first RDU coupled together using a local interconnect, the first RDU further comprising a first interface to:
a pattern compute unit (PCU); and
a pattern memory unit (PMU) accessible to and integrated with the PCU,
wherein the first RDU is configured to receive configuration information via the local interconnect, wherein the configuration information indicates:
first initialization information usable to initialize the PCU via the first interface; and
second initialization information usable to initialize the PMU via the first interface.

2. The system of claim 1, wherein the first RDU further comprises:
a second interface to the local interconnect;
a third interface to a high-bandwidth memory (HBM) accessible to the PCU; and
a fourth interface to a dual data rate (DDR) memory accessible to the PCU,
wherein the configuration information further indicates:
third initialization information usable to initialize the the local interconnect via the second interface;
fourth initialization information usable to initialize HBM via the third interface; and
fifth initialization information usable to initialize the DDR memory via the fourth interface.

3. The system of claim 2, wherein the first RDU further comprises:
a first die and a second die communicatively coupled using a die-to-die (D2D) interface; and
a fifth interface to the D2D interface,
wherein the configuration information further indicates:
sixth initialization information to initialize the D2D interface via the fifth interface.

4. The system of claim 1, wherein the local interconnect includes or is coupled to a system interconnect accessible to a host in communication with the system.

5. The system of claim 4, wherein the system interconnect includes or is coupled to at least one of:
a peripheral component interconnect (PCI) bus;
an optical interconnect; or
an Ethernet network.

6. The system of claim 4, wherein the configuration information is sent by the host from a user space process using the system interconnect.

7. The system of claim 6, wherein the user space process is configured to access control and status registers (CSRs) in the first RDU.

8. The system of claim 3, wherein the first die further comprises:
a sixth interface to a reconfigurable dataflow network (RDN) in communication with the PCU and the PMU; and
a seventh interface to a top-level network (TLN) in communication with the RDN, and wherein the configuration information further indicates:
seventh initialization information to initialize the RDN via the sixth interface; and
eighth initialization information usable to initialize the TLN via the seventh interface.

9. The system of claim 3, wherein the first die further comprises:
an eighth interface to an address generation and coalescing unit (AGCU), and wherein the configuration information further indicates:
ninth initialization information to initialize the AGCU via the eighth interface.

10. A method comprising:
accessing, at a host, configuration information indicating initialization information for a system comprising a plurality of reconfigurable dataflow units (RDUs), including a first RDU, coupled together using a local interconnect;
sending the configuration information to the system using a system interconnect included with or coupled to the local interconnect, including sending at least some of the configuration information to the first RDU;
sending, to a first interface at the first RDU, first initialization information indicated in the configuration information, the first initialization information usable to initialize a pattern compute unit (PCU) included in the first RDU;
sending, to the first interface, second initialization information indicated in the configuration information, the second initialization information usable to initialize a pattern memory unit (PMU) accessible to and integrated with the PCU;
sending, to a second interface at the first RDU, third initialization information indicated in the configuration information, the third initialization information usable to initialize the local interconnect;
sending, to a third interface at the first RDU, fourth initialization information indicated in the configuration information, the fourth initialization information usable to initialize a high-bandwidth memory (HBM) accessible to the PCU; and
sending, to a fourth interface at the first RDU, fifth initialization information indicated in the configuration information, the fifth initialization information usable to initialize a dual data rate (DDR) memory accessible to the PCU.

11. The method of claim 10, wherein the system interconnect includes or is coupled to at least one of:
a peripheral component interconnect (PCI) bus;
an optical interconnect; or
an Ethernet network.

12. The method of claim 10, further comprising:
initializing the PCU using the first initialization information;
initializing the PMU using the second initialization information;
initializing the local interconnect using the third initialization information;
initializing the HBM using the fourth initialization information; and
initializing the DDR memory using the fifth initialization information.

13. The method of claim 10, further comprising:
sending, to a fifth interface at the first RDU, sixth initialization information indicated in the configuration information and usable to initialize a die-to-die (D2D) interface that communicatively couples a first die and a second die included in the first RDU;
sending, to a sixth interface at the first RDU, seventh initialization information indicated in the configuration information and usable to initialize an address generation and coalescing unit (AGCU) included in the first RDU;
initializing the D2D interface using the sixth initialization information; and
initializing the AGCU using the seventh initialization information.

14. The method of claim 13, further comprising:
sending, to a seventh interface at the first RDU, eighth initialization information indicated in the configuration information and usable to initialize a reconfigurable dataflow network (RDN) included in the first RDU;
sending, to a eighth interface at the first RDU, ninth initialization information indicated in the configuration information and usable to initialize a top-level network (TLN) included in the first RDU;
initializing the RDN using the eighth initialization information; and
initializing the TLN using the ninth initialization information.

15. Tangible computer-readable media comprising instructions executable by a computer system to:
access, at a host, configuration information indicating initialization information for a system comprising a plurality of reconfigurable dataflow units (RDUs), including a first RDU, coupled together using a local interconnect;
send the configuration information to the system using a system interconnect included with or coupled to the local interconnect, including sending at least some of the configuration information to the first RDU;
send, to a first interface at the first RDU, first initialization information indicated in the configuration information, the first initialization information usable to initialize a pattern compute unit (PCU) included in the first RDU;
send, to the first interface, second initialization information indicated in the configuration information, the second initialization information usable to initialize a pattern memory unit (PCU) accessible to and integrated with the PCU;
send, to a second interface at the first RDU, third initialization information indicated in the configuration information, the third initialization information usable to initialize the local interconnect;
send, to a third interface at the first RDU, fourth initialization information indicated in the configuration information, the fourth initialization information usable to initialize a high-bandwidth memory (HBM) accessible to the PCU; and
send, to a fourth interface at the first RDU, fifth initialization information indicated in the configuration information, the fifth initialization information usable to initialize a dual data rate (DDR) memory accessible to the PCU.

16. The computer-readable media of claim 15, wherein the system interconnect includes or is coupled to at least one of:
a peripheral component interconnect (PCI) bus;
an optical interconnect; or
an Ethernet network.

17. The computer-readable media of claim 15, further comprising instructions executable by the computer system to:
initialize the PCU using the first initialization information;
initialize the PMU using the second initialization information;
initialize the local interconnect using the third initialization information;
initialize the HBM using the fourth initialization information; and
initialize the DDR memory using the fifth initialization information.

18. The computer-readable media of claim 15, further comprising instructions executable by the computer system to:
send, to a fifth interface at the first RDU, sixth initialization information indicated in the configuration information and usable to initialize a die-to-die (D2D) interface that communicatively couples a first die and a second die included in the first RDU;
send, to a sixth interface at the first RDU, seventh initialization information indicated in the configuration information and usable to initialize an address generation and coalescing unit included in the first RDU;
initialize the D2D interface using the sixth initialization information; and
initialize the address generation and coalescing unit using the seventh initialization information.

19. The computer-readable media of claim 15, further comprising instructions executable by the computer system to:
send, to a seventh interface at the first RDU, eighth initialization information indicated in the configuration information and usable to initialize a reconfigurable dataflow network (RDN) included in the first RDU;
send, to a eighth interface at the first RDU, ninth initialization information indicated in the configuration information and usable to initialize a top-level network (TLN) included in the first RDU;
initialize the RDN using the eighth initialization information; and
initialize the TLN using the ninth initialization information.

20. The computer-readable media of claim 15, wherein the computer system is the host.
